(19) United States
(12) Patent Application Publication
(10) Pub. No.: US 2002/0142812 A1
(43) Pub. Date: Oct. 3, 2002

(54) Cellular telephone with integrated charging circuit

(76) Inventor: Richard M. Goodman, Detroit, MI (US)

Correspondence Address: HARNESS, DICKEY & PIERCE, P.L.C., P.O. BOX 828, BLOOMFIELD HILLS, MI, 48303, US

(21) Appl. No.: 09/824,339

(22) Filed: Apr. 2, 2001

(51) Int. Cl. H04M 1/00

(52) U.S. Cl. 455/572; 455/573; 455/575; 455/90

(57) ABSTRACT

A rechargeable cellular telephone includes a rechargeable battery connected to an integrated recharging system, which is connected to a plug adapted to engage an electrical outlet to supply electricity to the recharging system and battery. The recharging system is preferably housed either within the telephone body or within the plug. The telephone body may include a storage area and spring-loaded reel for storing the cord. The recharging system may include a rectifier, a transformer, and a voltage regulator. The plug may be clipped to the telephone body, or include retractable prongs.

### FIELD OF THE INVENTION

The present invention relates generally to cellular telephones and specifically to recharging cellular telephone batteries.

### DISCUSSION

Because of their size and convenience, cellular telephones are becoming increasingly popular today. Cellular telephones are commonly powered by batteries, which have a limited charge capacity, thus limiting the amount of time a cellular telephone can be used. Today, most cellular telephones are equipped with rechargeable batteries to reduce the cost, waste, and inconvenience of single-use batteries.

As cellular telephones become more universal in use, the necessity of an independent charging device becomes an increasing nuisance. One source of inconvenience associated with the use of rechargeable batteries in cellular telephones is that recharging the batteries requires the use of additional equipment external to the phone. For example, a common method of recharging a cellular telephone battery involves using an external charging circuit to connect the cellular telephone to an AC power supply via a standard electrical outlet. The charging circuit converts AC electrical power from the wall outlet into DC power needed to recharge the battery. If this charging circuit is unavailable to the user, either because it is lost, misplaced, or forgotten, the battery life of the phone is limited to a single charge. Thus it is desirable to have a solution that recharges the battery of a cellular telephone without having to use an additional piece of equipment.

### SUMMARY OF THE INVENTION

A cellular telephone according to the invention is rechargeable by directly engaging an electrical outlet. The cellular telephone includes a rechargeable battery mounted to a cellular telephone body, a battery recharging system housed internally to the cellular telephone body and electrically coupled to the battery, and a plug that is directly connected to the battery recharging system. The plug interfaces an electrical outlet to supply electricity to the recharging system which recharges the battery.

In one preferred embodiment, the plug is connected to the battery recharging system using a cord, which is stored in a storage area within the body of the cellular telephone. In another preferred embodiment, the plug is mounted directly to an external surface of the body of the cellular telephone.

### BRIEF DESCRIPTION OF THE DRAWINGS

The various advantages of the present invention will become apparent to one skilled in the art by reading the following specification and subjoined claims and by referencing the following drawings in which:

FIG. 1 is a front view of a cellular telephone according to the invention;

FIG. 2 is a side view of a cellular telephone of FIG. 1;

FIG. 3 is a front view of a cellular telephone with a DC plug clipped to the top of the phone in accordance with a preferred embodiment of the present invention;

FIG. 4 is a side of the cellular telephone of FIG. 3 with the DC plug engaging an outlet for DC electricity in accordance with a preferred embodiment of the present invention;

FIG. 5 is a side view of a cellular telephone with an AC plug engaging a source of AC electricity in accordance with a preferred embodiment of the present invention;

FIG. 6 is a rear view of the cellular telephone of FIG. 3 with a storage area shown in hidden lines;

FIG. 7 is a perspective view of a spring-loaded reel and DC plug for use with the cellular telephone of FIGS. 3 and 4;

FIG. 7a is a perspective view of an AC plug that can be used with the spring-loaded reel of FIG. 7 as an alternative to the DC plug in conjunction with the cellular telephone of FIGS. 5 and 6;

FIG. 8 is a side view of a cellular telephone equipped with retractable prongs in accordance with another preferred embodiment of the present invention;

FIG. 9 is a rear view of the cellular telephone in FIG. 8;

FIG. 10 is a side view of the cellular telephone of FIG. 8 shown interfacing an electrical outlet;

FIG. 11 is a circuit diagram of a cellular telephone recharging system in accordance with a preferred embodiment of the present invention;

FIG. 12 is a circuit diagram of a cellular telephone recharging system in accordance with another preferred embodiment of the present invention;

FIG. 13a is a side view of a set of pivoting AC prongs in a stored position; and

FIG. 13b is a side view of a set of pivoting AC prongs in an engaged position.

### DETAILED DESCRIPTION OF THE PREFERRED EMBODIMENT

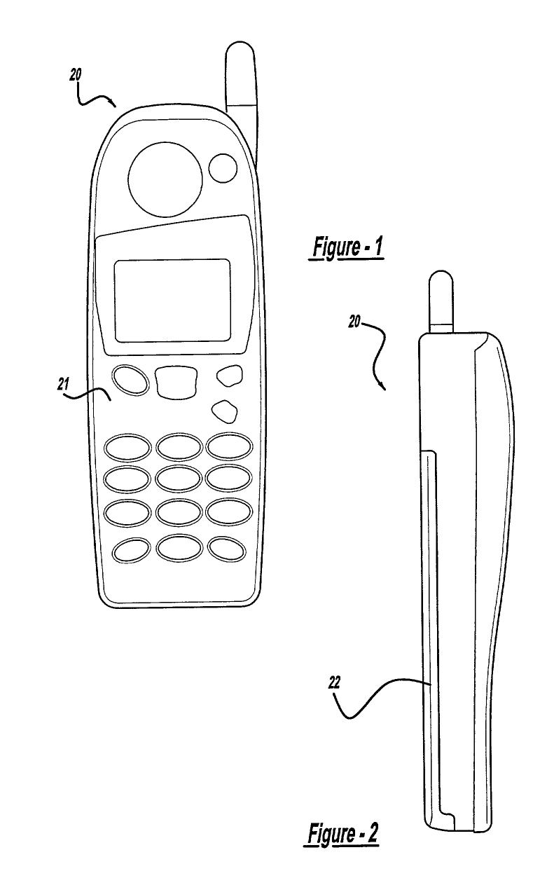

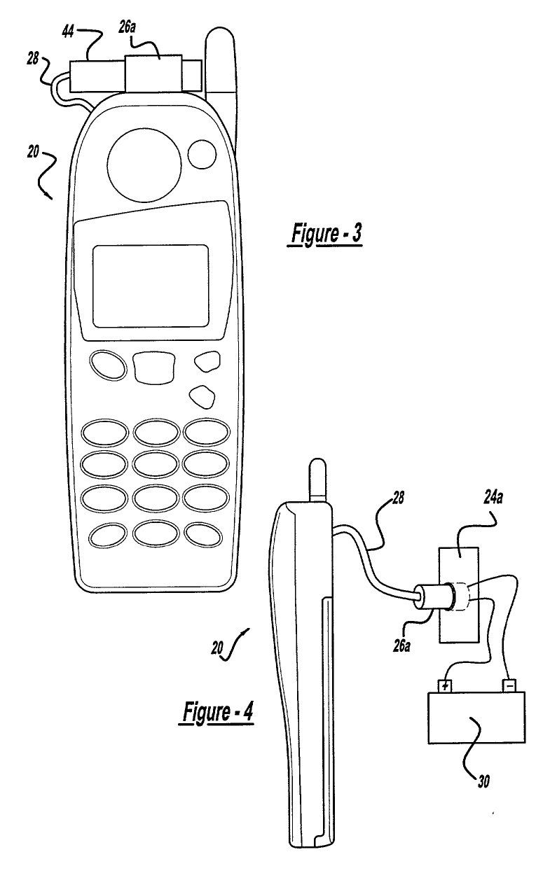

With reference to FIGS. 1 and 2, there is shown a cellular telephone 20 powered by a rechargeable battery 22 that is integrated within a body 21 of the cellular telephone. With reference to FIGS. 3 through 6, there is shown the cellular telephone 20 that can be directly engaged with an electrical outlet 24a, 24b through an electrical interface plug 26a, 26b, 26c in accordance with a preferred embodiment of the present invention. The plug 26b, 26c is an AC-type plug, while the plug 26a is a DC-type plug. With reference to FIGS. 4 and 5, the plug 26a, 26b is coupled to the cellular telephone 20 using an electrically conducting cord 28. The plug 26a engages directly with an electrical outlet 24a, which is of DC type, while the plug 26b, 26c directly engages with a plug 24b, which is of AC type. The electrical outlet 24 provides a source of electricity that is used to recharge the cellular telephone battery 22.

In one mode of operation, the electrical outlet 24a is a DC electrical outlet. This electrical outlet 24a can be an automotive vehicle electrical outlet providing 12 volts, such as that conventionally supplied by a vehicle battery 30. The electrical outlet 24a could be, for example, a vehicle's cigarette lighter, another outlet on a vehicle's console or in a vehicle's trunk, or any other DC electrical outlet. The plug 26a is fashioned to engage a DC electrical outlet. In this mode of operation, it may be possible to connect the plug 26a directly to the cellular telephone battery 22 to recharge the battery 22, if the properties of the DC electricity are within the acceptable range of the cellular telephone battery 22.

If the properties of the DC power source 24a do not fall within the acceptable range, with reference to FIG. 12, a recharging system 32a can be used to adjust the properties of the electrical current to be acceptable to the cellular telephone battery 22. In a preferred embodiment of the present invention, the recharging system 32a includes a voltage regulator 34 to produce a nearly constant voltage output even though the voltage input and current output may vary widely. The recharging system 32a includes a DC power supply that provides DC power to the recharging system 32a. The recharging system 32a further includes two capacitors C₁ and C₂, which are connected in parallel with respect to a voltage regulator 34. The recharging system 32a is electrically connected to the cellular telephone battery 22 and the plug 26a. In this preferred embodiment, the recharging system 32a is located within the body of the cellular telephone 20. In another preferred embodiment of the present invention, the recharging system 32a is located in the plug 26a.

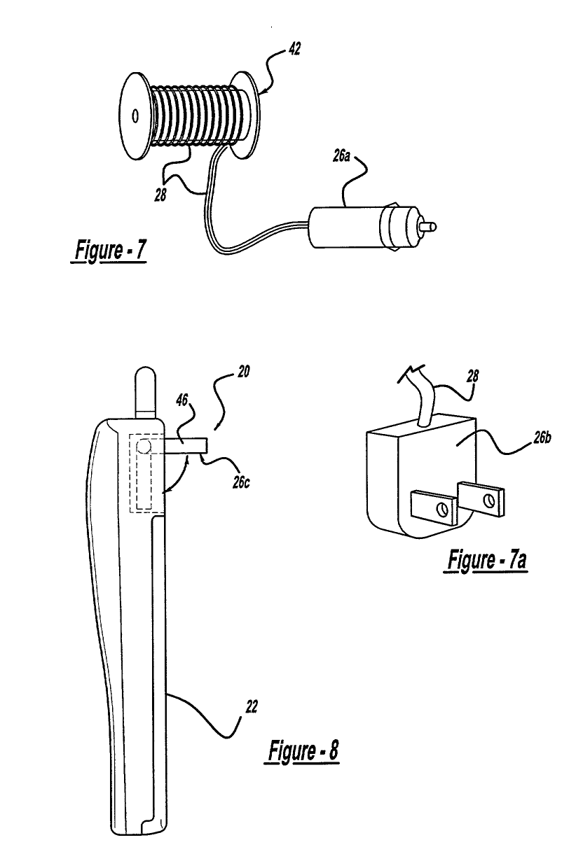

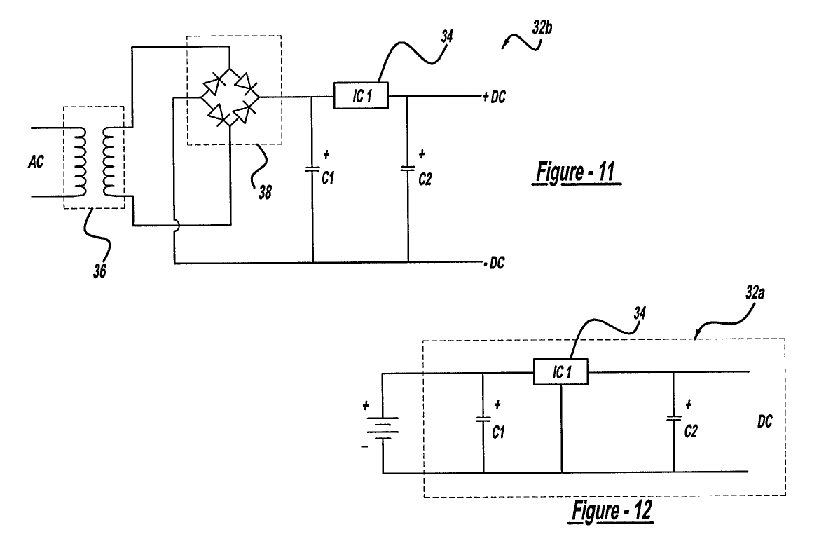

With reference to FIG. 5, in another mode of operation, the electrical outlet 24b is an AC electrical outlet, such as a standard US 115 volt outlet. One skilled in the art will recognize that any of a number of standard electrical outlets, such as those employed in other countries, are within the scope of the present invention. With reference to FIG. 7a and further reference to FIG. 5, the plug 26b is fashioned to interface the AC electrical outlet 24b. Because the cellular telephone battery 22 must be recharged using a DC power supply, a recharging system 32b, as shown in FIG. 11, is employed to convert the electrical current from AC to DC, to provide an acceptable DC voltage level, and to regulate the voltage. The recharging system 32b is electrically connected to the cellular telephone battery 22 and the plug 26b. The recharging system 32b includes a voltage regulator 34, a transformer 36, and rectifier 38 to convert the AC power to DC power of an acceptable voltage for recharging the cellular telephone battery 22. Further, capacitors C₁ and C₂ are connected in parallel to the voltage regulator 34. The space occupied by the transformer 36 will depend on the current passing through and the energy storing capability of the capacitors C₁ and C₂. The size of the transformer 36 is chosen based on a balancing of the permissible space within the telephone 20 and the desired charging time required.

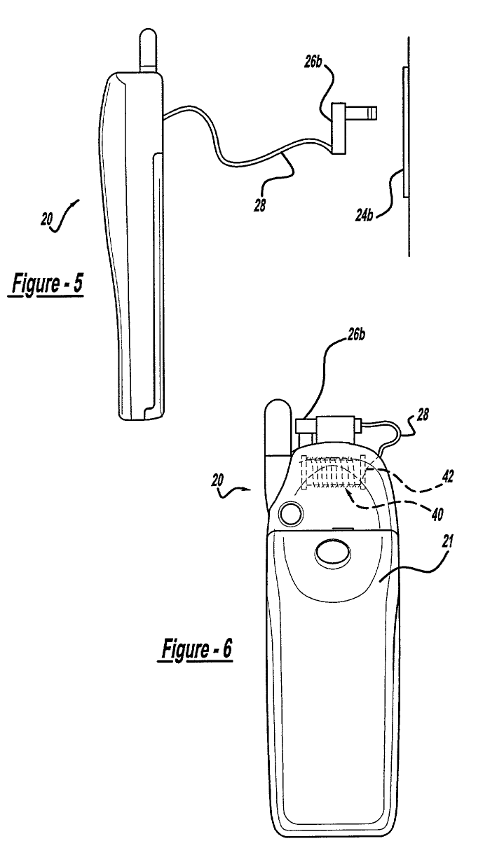

With reference to FIG. 6, in a preferred embodiment of the present invention, the cord 28 is stored in a storage area 40 defined within the body 21 of the cellular telephone 20. This minimizes any inconvenience associated with a length of cord 28 external to the phone 20. With reference to FIGS. 6 and 7, in this preferred embodiment, the storage area 40 includes a spring-loaded reel 42, around which the cord 28 can be wrapped for storage. Because a spring-loaded reel 42 is used, the length of the cord 28 not in use is automatically retracted to be within the storage area 40 and thus conveniently stored.

With reference to FIGS. 3 and 6, in a preferred embodiment of the present invention, the plug 26a, 26b is fastened to the telephone body 31 by a clip 44 for storage. Thus, when the plug 26a,b is not engaged with an electrical outlet 24a, 24b, it can be conveniently stored by clipping it to the phone 20. The clip 44 is preferably located on the top of the phone 20, although one skilled in the art will recognize the scope of the present invention encompasses clips mounted at any of a variety of locations on the cellular telephone. Further, the telephone body 31 can be formed to provide a recess to accommodate the plug 26a, 26b, preferably including an integral clip to retain the plug 26a, 26b.

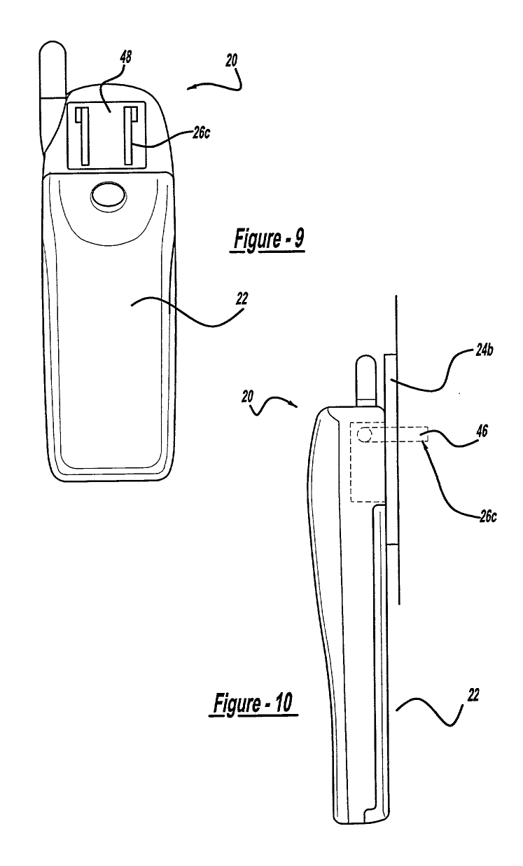

With reference to FIGS. 8 through 10, in another preferred embodiment of the present invention the plug 26c includes electrically conducting prongs 46 that are directly mounted onto telephone body 21. As shown, he plug 26c is fashioned to engage an AC electrical outlet 26b. Preferably, the plug 26c is coupled to the recharging system 32b described above. In a preferred embodiment of the present invention, the recharging system 32b is located within the interior of the cellular telephone, preferably close to the plug to minimize any hazard as discussed above.

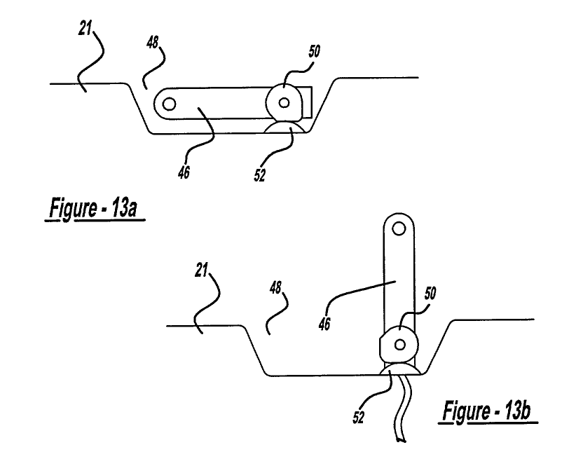

In a preferred embodiment, the prongs 46 of the plug 26c are retractable, and thus move between a use position and a storage position. With reference to FIGS. 13a and b, in one mode of operation, the prongs 46 are mounted to pivot relative to the telephone body 21 between the use position, where the prongs 46 extend outwardly from the telephone body 21 to be in position to engage the electrical outlet 24b, and the storage position, where the prongs 46 are disposed in a recess 48 on an exterior surface of the cellular telephone body 21. To facilitate this movement, the prongs 46 pivot along a pivot 50 which includes flats to define the storage and use positions. When the prongs 46 of the plug 26c are pivoted from the storage position to the use position, an interior portion of the prongs 46 are brought into contact with contacts 52, which are preferably a leaf spring that electrically connect the prongs 46 to the recharging system 32b.

With reference to FIG. 10, the plug 26c engages the electrical outlet 24b directly when the phone is plugged into the outlet 24b. In a preferred embodiment, the prongs 46 and plug 26c are fashioned to support the weight of the cellular telephone 20 when the cellular telephone 20 is connected to electrical outlet 24b. The prongs 46 can be located at any of a variety of locations on the exterior of the cellular telephone 20, although locating the prongs 46 near the top of the cellular telephone 20 and above the center of gravity of the cellular telephone 20 allows for better support.

In a preferred embodiment of the present invention, the recharging system 32b is housed within the body of the cellular telephone 20, preferably close to the exterior interface between the cord 28 and the phone body 21, thus minimizing any safety hazard that could result from the AC power. In another preferred embodiment, the recharging system 32b is located in the plug 26. In yet another embodiment of the invention, the cellular telephone 20 includes both recharging circuits 32a and 32b. For example, in this version of the invention, the cellular telephone 20 can use either an AC or DC electrical outlet to recharge the battery and may include both plugs 26a and 26c to facilitate such recharging options.

The above-described embodiments have the important advantage that a cellular telephone can be recharged without using additional equipment. This eliminates the problem of forgetting or misplacing recharging equipment, which can leave a user without the use of a cellular telephone.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and following claims.

What is claimed is:

1. A rechargeable cellular telephone that is selectively connected to a source of electricity via an electrical outlet, the cellular telephone comprising:
a cellular telephone body;
a rechargeable battery mounted to said cellular telephone body;
a battery charging system housed within said cellular telephone body and electrically connected to said battery; and
a plug fixedly connected to said battery charging system and selectively connected to the electrical outlet, whereby said battery recharges when said plug is connected to electricity via said electrical outlet.

2. The cellular telephone of claim 1, further comprising an electrically conducting cord, wherein said plug is fixedly connected to said battery charging system through said cord.

3. The cellular telephone of claim 2, further comprising a storage area inside said cellular telephone body for storing said cord.

4. The cellular telephone of claim 3, further comprising a spring-loaded reel mounted within said storage area for storing said cord by winding it around said reel, and wherein said reel causes said cord to be automatically retracted into said storage area.

5. The cellular telephone of claim 1, wherein said battery charging system comprises a dropping resistor to alter the electricity supplied via the electrical outlet from a first voltage to a second lower voltage.

6. The cellular telephone of claim 1, wherein said battery charging system comprises an AC to DC converter to convert AC electricity supplied via the electrical outlet to DC electricity supplied to said battery.

7. The cellular telephone of claim 6, wherein said battery charging system comprises a dropping resistor to alter the electricity supplied via the electrical outlet from a first voltage to a second lower voltage.

8. The cellular telephone of claim 1, wherein said battery charging system includes a voltage regulator to produce a nearly constant voltage output to said battery.

9. The cellular telephone of claim 1, wherein said plug includes a set of electrically conducting prongs mounted to an exterior surface of the telephone body.

10. The cellular telephone of claim 9, wherein said prongs are moveable between a use position, wherein said prongs are positioned for reception by the electrical outlet, and a storage position, wherein said prongs are recessed relative said cellular telephone body.

11. The cellular telephone of claim 10, wherein said prongs are rotatable between said use position and said storage position.

12. The cellular telephone of claim 11, wherein said prongs are disposed within a recess in said cellular telephone body when in said storage position.

13. A cellular telephone that is selectively connected to a source of electricity via an electrical outlet, the cellular telephone comprising:
a cellular telephone body;
a rechargeable battery mounted to said cellular telephone body;
a battery charging system housed within said cellular telephone body and connected to said battery; and
a set of electrically conducting prongs mounted to said cellular telephone body and fixedly electrically connected to said battery charging system, said prongs being selectively received by the electrical outlet to recharge said battery.

14. The cellular telephone of claim 11, wherein said prongs are moveable between a use position, wherein said prongs are positioned for reception by the electrical outlet, and a storage position, wherein said prongs are recessed relative said cellular telephone body.

15. The cellular telephone of claim 14, wherein said prongs are rotatable between said use position and said storage position.

16. The cellular telephone of claim 15, wherein said prongs are disposed within a recess in said cellular telephone body when in said storage position.

17. The cellular telephone of claim 13, wherein said battery charging system comprises an AC to DC converter to convert AC electricity supplied via the electrical outlet to DC electricity supplied to said battery.

18. The cellular telephone of claim 17, wherein said battery charging system comprises a dropping resistor to alter the electricity supplied via the electrical outlet from a first voltage to a second lower voltage.

19. The cellular telephone of claim 13, wherein said battery charging system includes a voltage regulator to produce a nearly constant voltage output to said battery.

20. A cellular telephone that is selectively connected to a source of electricity via an electrical outlet, the cellular telephone comprising:
a cellular telephone body;
a rechargeable battery mounted to said cellular telephone body;
a recharging circuit in said cellular telephone body and electrically connected to said battery;
a plug electrically connected to said battery through said recharging circuit, said plug selectively received by the electrical outlet to recharge said battery;
an electrical conducting cord electrically connected to said recharging circuit and extendable between said cellular telephone body and the electrical outlet to recharge said battery; and
a storage area within the cellular telephone body, said cord selectively stored in said storage area when said plug is disengaged from the electrical outlet.

21. The cellular telephone of claim 20, further comprising a spring-loaded reel in said storage area to automatically retract said cord into said storage area from an extended position to a storage position.

22. The cellular telephone of claim 20, further comprising a plug storage clip, said clip releasably fastening said plug to said cellular telephone body.

23. The cellular telephone of claim 20, wherein said recharging circuit includes a voltage converter for converting a DC voltage of a DC power source to a DC voltage for recharging the rechargeable battery.

24. The cellular telephone of claim 20, wherein said battery charging system comprises an AC to DC converter to convert AC electricity supplied via the electrical outlet to DC electricity supplied to said battery.

25. The cellular telephone of claim 24, wherein said battery charging system comprises a dropping resistor to alter the electricity supplied via the electrical outlet from a first voltage to a second lower voltage.

26. The cellular telephone of claim 20, wherein said battery charging system includes a voltage regulator to produce a nearly constant voltage output to said battery.
